(19) United States
(12) Patent Application Publication
(10) Pub. No.: US 2019/0339045 A1
(43) Pub. Date: Nov. 7, 2019

(54) MOUNTABLE VEHICLE IMPLEMENT

(71) Applicant: PEARSON ENGINEERING LTD., Tyne and Wear (GN)

(72) Inventors: James SIMPSON, Durham (GB); Peter COUCHMAN, Tyne and Wear (GB)

(21) Appl. No.: 16/061,634

(22) PCT Filed: Nov. 17, 2016
(86) PCT No.: PCT/GB2016/053585

§ 371 Date: Jun. 12, 2018

(30) Foreign Application Priority Data
Dec. 13, 2015 (GB) 1521932.2

(51) Int. Cl. F41H 11/24; E02F 3/627; B60D 1/46

(52) U.S. Cl. CPC F41H 11/24; B60D 2001/001; B60D 1/46; E02F 3/6273

(57) ABSTRACT

A mountable vehicle implement (10) is provided and comprises a mounting region at or towards one end for mounting the implement on a vehicle (20). The implement is height adjustable to adjust the height of the mounting region, and the implement comprises means for adjusting the angle of the mounting region so that it is matched to a cooperating mounting region on a vehicle.

The present invention relates generally to an implement, for example an item of front end equipment for a vehicle, and particularly to an implement which can be transformed from a stored position to a mounting position.

In a first aspect the present invention provides a mountable vehicle implement comprising a mounting region at or towards one end for mounting the implement on a vehicle, the implement being height adjustable to adjust the height of the mounting region, the implement comprising means for adjusting the angle of the mounting region so that it is matched to a cooperating mounting region on a vehicle.

When the mounting region is at a required height it may be partially securable to a cooperating vehicle mounting region and thereafter is rotatable to match so as to be fully securable. Alternatively the height and the angle of the implement mounting region may be adjusted to generally match the cooperating vehicle mounting region prior to securement thereto.

The implement may be height adjustable using onboard height adjustment means, such as one or more jacks (powered or unpowered).

In a further aspect the present invention provides a mountable vehicle implement comprising a mounting region for mounting the implement on a vehicle, the implement being movable from a stored position to an intermediate position and subsequently being movable from the intermediate position to a mounting position in which the mounting region is matched to a cooperating mounting region on a vehicle.

The present invention enables transformation of the equipment from the stored position to the mounting position solely using on-board features i.e. no additional equipment is required in order to be able to ready the equipment to be directly received on the vehicle.

At least part of the implement may be raised as it is moved from the storage position to the intermediate position.

One or more on-board lifting devices, for example a jack, ram or the like, may be provided for raising the implement to the intermediate position. The lifting device/s may be unpowered; for example the equipment may be mechanically raised on jacks.

At least part of the implement may be rotated from the intermediate position to the mounting position. For example, the implement part is configured in a clam shell type arrangement, with the arrangement opening to rotate a mounting plate as the implement moves from the intermediate position to the mounting position.

One or more on-board rams may be provided to convert the implement from the intermediate position to the mounting position. For example a hydraulically operated cylinder may be provided, with extension of the cylinder causing a mounting plate to be rotated into a required mounting orientation.

The mounting region may comprise a mounting plate. The plate and the cooperating region on the vehicle may have geometric features on the part which couple with each other, necessitating a particular relative orientation of the implement and the vehicle before mounting can be achieved.

The dismountable implement may be moved from the intermediate position to the mounting position to match the angle of the mounting plate to the angle of the vehicle mounting region.

Movement from the intermediate position to the mounting position may be powered by the vehicle. For example an electrical power coupling may be established from the vehicle to the implement to power hydraulic transformation from the intermediate position to the mounting position. Hydraulic pressure may be generated on-board the equipment i.e. the vehicle only provides the power to allow the implement to convert itself.

Hydraulic components (for example a hydraulic motor pump, hydraulic manifold and hydraulic pressure filter) may be provided on the implement, for example in the mounting plate.

Controls for movement of the implement may, for example, be provided by a control box connected to the mounting plate (and operable, for example, in the vehicle) and/or on or by the mounting plate.

The implement may be an item of front end equipment, such as a mine plough; for example a plough for a military vehicle such as a tank.

The present invention also provides a vehicle fitted with an implement as claimed in any preceding claim.

The present invention also provides a method of attaching front end equipment to a vehicle comprising the steps of: A) raising the equipment from a stored position to an intermediate position using on-board lifting means; B) rotating part of the equipment to a mounting position using on-board rotation means so as to match an implement mounting region to a cooperating mounting region on a vehicle; and C) coupling the implement to the vehicle.

After step A) a power supply may be fed from the vehicle to the equipment to enable powering of step B).

A further aspect provides a mountable vehicle implement comprising a mounting region for mounting the implement on a vehicle, the implement being movable from a stored position to an intermediate position and subsequently being movable from the intermediate position to a mounting position in which the mounting region is matched to a cooperating mounting region on a vehicle, the implement comprising a fixed arm which is pivotally connected to the mounting region, and means for rotating the mounting region with respect to the fixed arm so as to match the mounting region to the vehicle mounting region.

A further aspect provides a method of readying an implement for mounting on a vehicle, the implement comprising a mounting region at or towards one end for mounting the implement on the vehicle, the method comprising the steps of adjusting the height of the implement to adjust the height of the mounting region, and adjusting the angle of the mounting region so that it is matched to a cooperating mounting region on a vehicle.

In some embodiments when the implement is at a required height part of the mounting region may be attached to the vehicle, and thereafter the mounting region may be rotated to allow a further part to be connected to the vehicle.

In some embodiments the height and angle of the mounting region may be adjusted to substantially required levels prior to connection to the vehicle.

Different aspects and embodiments of the invention may be used separately or together.

Further particular and preferred aspects of the present invention are set out in the accompanying independent and dependent claims. Features of the dependent claims may be combined with the features of the independent claims as appropriate, and in combination other than those explicitly set out in the claims.

The present invention will now be more particularly described, by way of example, with reference to the accompanying drawings, in which:

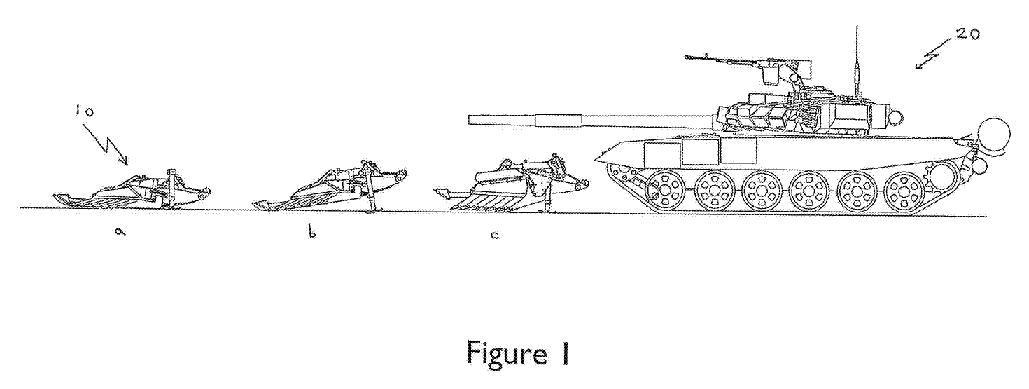

FIG. 1 shows an overview of the mounting system of the present invention;

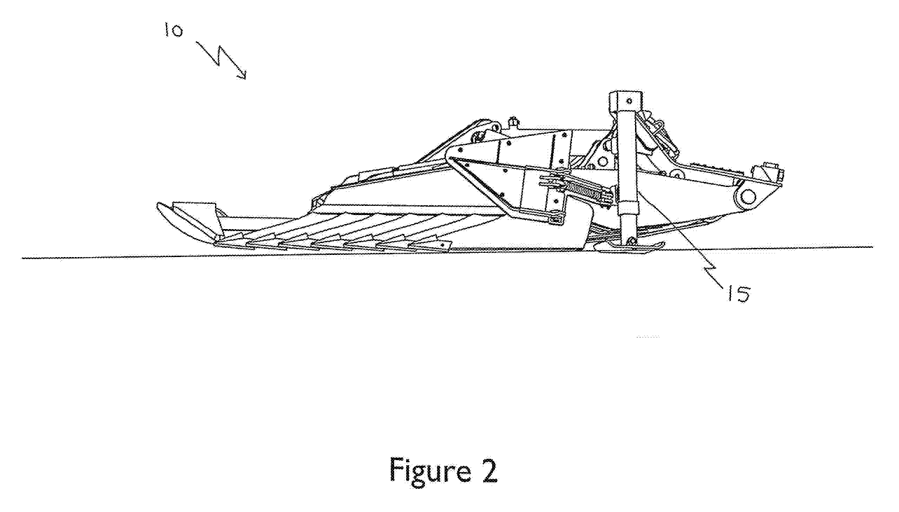

FIG. 2 shows an implement in a stored position;

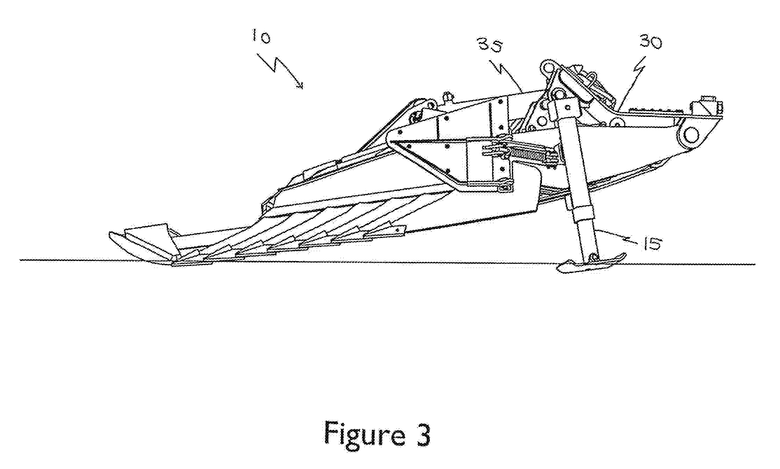

FIG. 3 shows a first fitting stage in more detail;

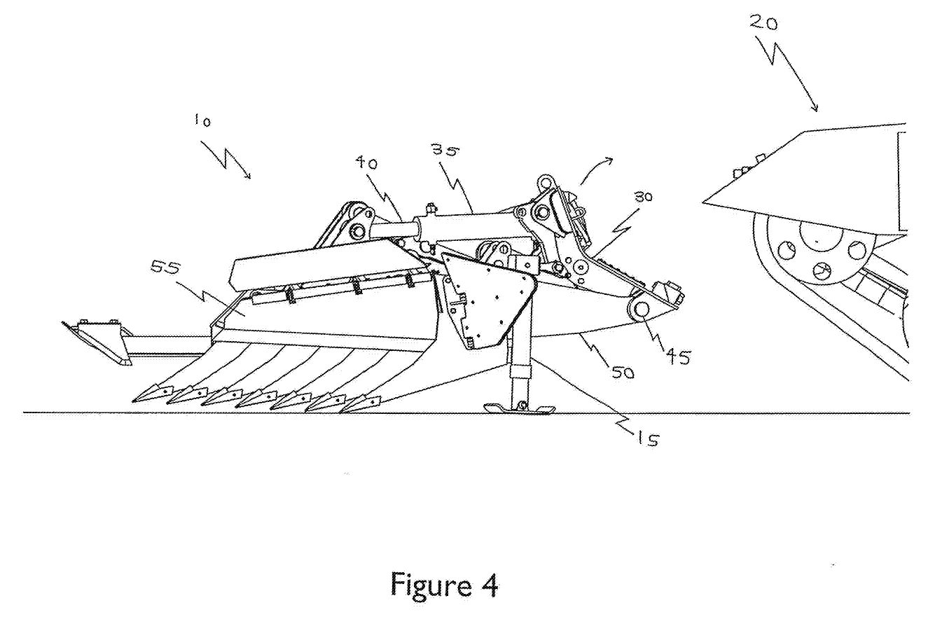

FIG. 4 shows a second fitting stage in more detail;

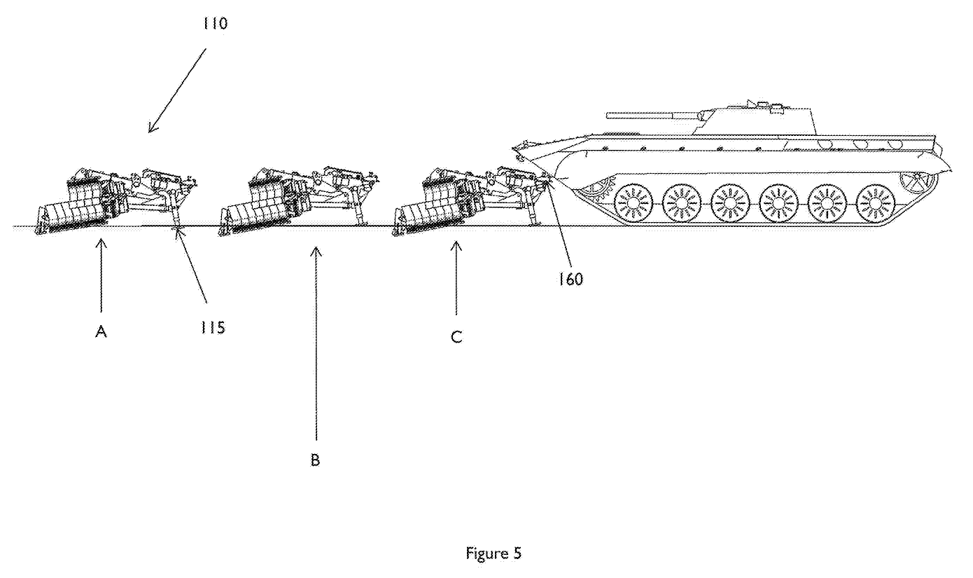

FIG. 5 shows a first fitting stage of an implement formed as a further embodiment;

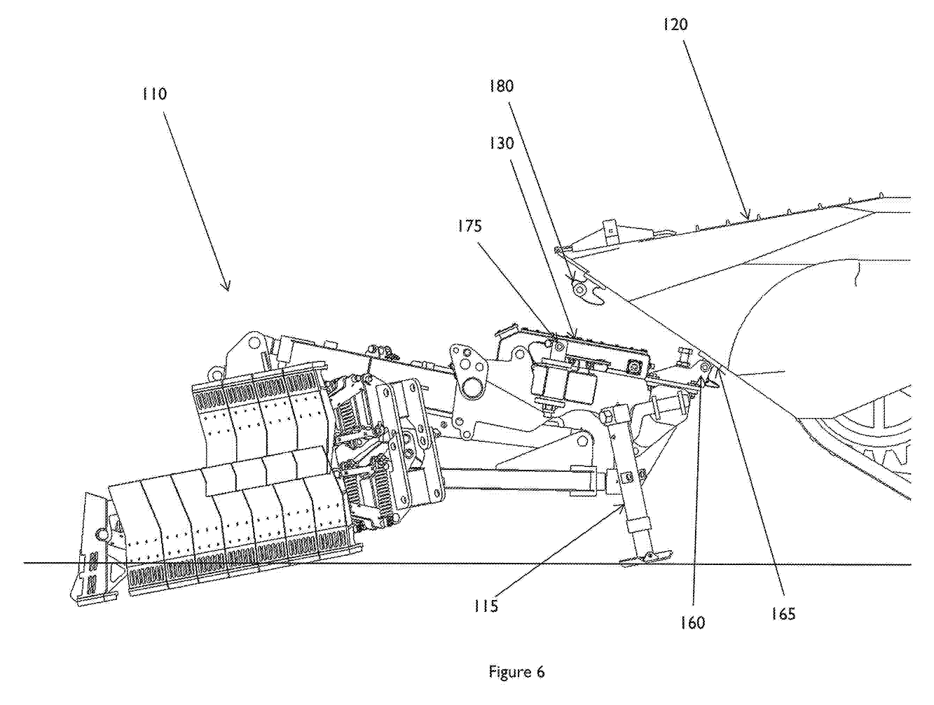

FIG. 6 shows the implement of FIG. 5 partially fixed to a vehicle; and

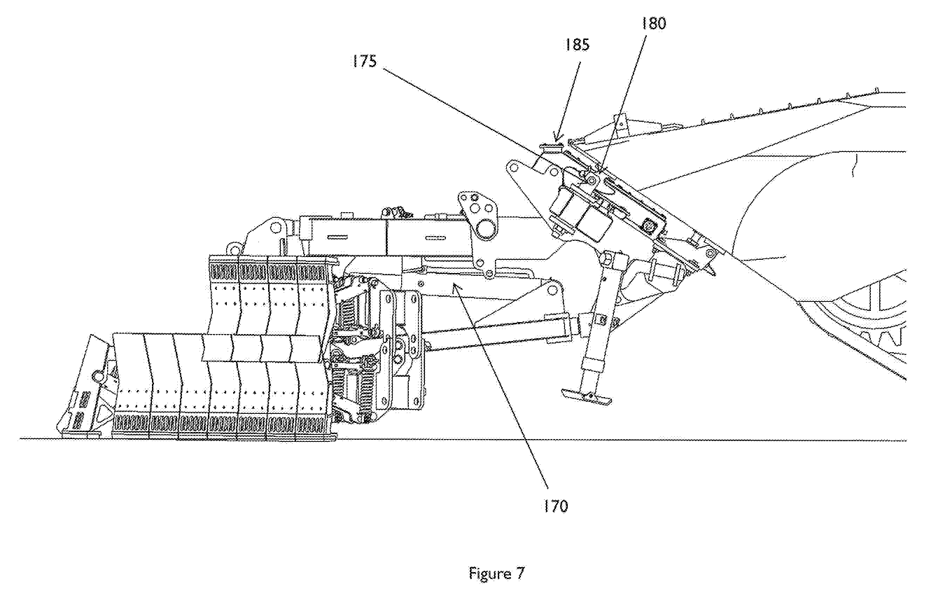

FIG. 7 shows the implement of FIG. 6 following a second fitting stage.

The example embodiments are described in sufficient detail to enable those of ordinary skill in the art to embody and implement the systems and processes herein described. It is important to understand that embodiments can be provided in many alternate forms and should not be construed as limited to the examples set forth herein.

Accordingly, while embodiment can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

In the following description, all orientational terms, such as upper, lower, radially and axially, are used in relation to the drawings and should not be interpreted as limiting on the invention.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

Referring now to the drawings, wherein like reference numbers are used to designate like elements throughout the various views, several embodiments of the present invention are further described. The figures are not necessary drawn to scale, and in some instances the drawings may have been exaggerated or simplified for illustrative purposes only. One of ordinary skill in the art will appreciate the many possible applications and variations of the present invention based on the following examples of possible embodiments of the present invention.

Referring first to FIG. 1 there is shown a mountable/dismountable implement in the form of a mine plough generally indicated 10 which is intended to be mounted on a vehicle 20.

The plough 10 is shown in a stored position (a), an intermediate position (b) and a mounting position (c).

In FIG. 2 the plough 10 is shown in a stored position. In this position the mounting plate 30 is collapsed forwards and at a low point on jacks 15.

In FIG. 3 the plough has been moved from the stored position to an intermediate position. In this embodiment this is achieved by mechanically raising up the plough from the rear end by the jacks 15.

In this embodiment the plough 10 and vehicle 20 are now electrically/hydraulically connected.

In FIG. 4 the mounting plate 30 of the plough is then rotated up to match the angle of the attachments on the front of the vehicle. For this purpose a hydraulic cylinder 35 is provided. As the cylinder rod 40 extends the mounting plate 30 rotates relative to a fixed lower arm 50 about a pivot point 45; and there is relative rotation between the arm 50 and the blade assembly 55. The equipment therefore effectively opens out.

When the mounting plate 30 is in the required orientation with respect to the vehicle the final stage of the mounting process is driving the vehicle forwards to meet the equipment.

The general principle of this embodiment is that in a first step the height of the mounting plate is set and in a second step the angle of the plate is set.

Referring now to FIGS. 5 to 7 there is shown an implement 110 formed according to a second embodiment. In this embodiment the implement is in the form of a surface mine clearance system.

FIG. 5 shows a preliminary mounting sequence in which in a first stage A the implement is positioned on jacks 115. At this stage the implement is at the wrong height for mounting on a vehicle.

At stage B the jacks 115 are used to raise the rear of the implement up so that lower mounting point/s (in this embodiment being a lower clevises 160) are at the correct height off the ground.

At stage C the implement is now in a mountable position. The vehicle 120 is driven up to the implement and the jacks 115 are used for fine adjustment to get the bottom clevises lined up with corresponding mounting points on the front end of the vehicle.

FIG. 6 shows the lower clevises 160 pinned to a lower mounting point 165 on the vehicle 120.

With the lower clevis 160 pinned to the vehicle, the electrical lead from the implement power pack I 85is connected to the vehicle. A lift cylinder 170 is then driven to rotate the mounting plate 130 until top clevises 175 align with the corresponding vehicle mounting points 180.

In this embodiment, therefore a three stage process is used, with the first stage being with the equipment on the jacks but at the wrong height, the second stage being to adjust to the correct height, and the third stage being inserting the lower pin, connecting power and rotating into position so that the upper pin can be inserted.

There are differences between the mounting sequences for the two embodiments discussed above.

For the second embodiment the jacks are left in position, so can be used to wind it up or down a bit. It is essential for the jacks to be in position. The equipment is in its fully closed up ‘stowed’ position, the same as the first embodiment. The first embodiment, however, can be left right down on the floor with jacks removed.

For the second embodiment, the first thing to do is to line up with the vehicle and use the jacks to get the right height to engage the two lower clevis pins with the vehicle.

The next step is to connect the electrical cable between equipment and vehicle. This supplies the power to the power pack, which then enables the cylinder to be driven. With the bottom clevises pinned to the vehicle, this rotates the mounting plate until the top clevises are aligned and can be pinned.

For the first embodiment the implement is brought to the correct height and rotated before it is attached to the vehicle. The implement of the second embodiment could be done that way in principle, but it may be easier/quicker to do in the way described because of the equipment configuration and the vehicle mounting arrangement.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention.

1-15. (canceled)

16. A mountable vehicle implement comprising a mounting region at or towards one end for mounting the implement on a vehicle, the implement being height adjustable to adjust the height of the mounting region, the implement comprising means for adjusting the angle of the mounting region so that it is matched to a cooperating mounting region on a vehicle, in which when the mounting region is at a required height it is partially securable to a cooperating vehicle mounting region and thereafter is rotatable to match so as to be fully securable.

17. The implement of claim 16, in which the implement is height adjustable using onboard height adjustment means.

18. The implement of claim 16, in which height adjustment is achieved using one or more jacks.

19. The implement of claim 16, in which the means for adjusting the angle of the mounting region comprise a ram.

20. The implement of claim 16, in which the means for adjusting the angle of the mounting region comprise a lift cylinder for rotating the mounting region.

21. The implement of claim 16, in which the mounting region comprises a mounting plate.

22. The implement of claim 16, in which the means for adjusting the angle of the mounting region is powered by the vehicle.

23. The implement of claim 16, in which the implement comprises a lower clevis for securing it to a vehicle when at the required height.

24. The implement of claim 16, in which the implement comprises a top clevis for securing it to a vehicle when the mounting region has been rotated.

25. The implement of claim 16, in which the implement is a mine plough.

26. A vehicle fitted with the implement of claim 16.
